(19) United States
(12) Patent Application Publication
(10) Pub. No.: US 2005/0047647 A1
(43) Pub. Date: Mar. 3, 2005

(54) System and method for attentional selection

(76) Inventors: Ueli Rutishauser, Pasadena, CA (US); Dirk Walther, Pasadena, CA (US); Christof Koch, Pasadena, CA (US); Pietro Perona, Pasadena, CA (US)

Correspondence Address: TOPE-MCKAY & ASSOCIATES, 23852 PACIFIC COAST HIGHWAY #311, MALIBU, CA, 90265, US

(21) Appl. No.: 10/866,311

(22) Filed: Jun. 10, 2004

Related U.S. Application Data
(60) Provisional application No. 60/477,428, filed on Jun. 10, 2003.
(60) Provisional application No. 60/523,973, filed on Nov. 21, 2003.

(51) Int. Cl. G06K 9/62; G06K 9/46

(52) U.S. Cl. 382/159; 382/190

(57) ABSTRACT

The present invention relates to a system and method for attentional selection. More specifically, the present invention relates to a system and method for the automated selection and isolation of salient regions likely to contain objects, based on bottom-up visual attention, in order to allow unsupervised one-shot learning of multiple objects in cluttered images.

### PRIORITY CLAIM

The present application claims the benefit of priority of U.S. Provisional Patent Application No. 60/477,428, filed Jun. 10, 2003, and titled “Attentional Selection for On-Line and Recognition of Objects in Cluttered Scenes” and U.S. Provisional Patent Application No. 60/523,973, filed Nov. 20, 2003, and titled “Is attention useful for object recognition?”

### STATEMENT OF GOVERNMENT INTEREST

This invention was made with Government support under a contract from the National Science Foundation, Grant No. EEC-9908537. The Government has certain rights in this invention.

### BACKGROUND OF THE INVENTION

(1) Technical Field

The present invention relates to a system and method for attentional selection. More specifically, the present invention relates to a system and method for the automated selection and isolation of salient regions likely to contain objects, based on bottom-up visual attention, in order to allow unsupervised one-shot learning of multiple objects in cluttered images.

(2) Description of Related Art

The field of object recognition has seen tremendous progress over the past years, both for specific domains such as face recognition and for more general object domains. Most of these approaches require segmented and labeled objects for training, or at least that the training object is the dominant part of the training images. None of these algorithms can be trained on unlabeled images that contain large amounts of clutter or multiple objects.

An example situation is one in which a person is shown a scene, e.g. a shelf with groceries, and then the person is later asked to identify which of these items he recognizes in a different scene, e.g. in his grocery cart. While this is a common task in everyday life and easily accomplished by humans, none of the methods mentioned above are capable of coping with this task.

The human visual system is able to reduce the amount of incoming visual data to a small, but relevant, amount of information for higher-level cognitive processing using selective visual attention. Attention is the process of selecting and gating visual information based on saliency in the image itself (bottom-up), and on prior knowledge about scenes, objects and their inter-relations (top-down). Two examples of a salient location within an image are a green object among red ones, and a vertical line among horizontal ones. Upon closer inspection, the “grocery cart problem” (also known as the bin of parts problem in the robotics community) poses two complementary challenges—serializing the perception and learning of relevant information (objects), and suppressing irrelevant information (clutter).

There have been several computational implementations of models of visual attenuation; see for example, J. K. Tsotsos, S. M. Culhane, W. Y. K. Wai, Y. H. Lai, N. Davis, F. Nuflo, “Modeling Visual-attention via Selective Tuning,” Artificial Intelligence 78 (1995) pp. 507-545, G. Deco, B. Schurmann, “A Hierarchical Neural System with Attentional Top-down Enhancement of the Spatial Resolution for Object Recognition,” Vision Research 40 (20) (2000) pp. 2845-2859, and L. Itti, C. Koch, E. Niebur, “A Model of Saliency-based Visual Attention for Rapid Scene Analysis,” IEEE Transactions on Pattern Analysis and Machine Intelligence, vol. 20 (1998) pp. 1254-1259. Further, some work has been done in the area of object learning and recognition in a machine vision context; see for example S. Dickinson, H. Christensen, J. Tsotsos, and G. Olofsson, “Active Object Recognition Integrating Attention and Viewpoint Control,” Computer Vision and Image Understanding, 63(67-3): 239-260 (1997), F. Miau, and L. Itti, “A Neural Model Combining Attentional Orienting to Object Recognition: Preliminary Explorations on the Interplay between Where and What,” IEEE Engineering in Medicine and Biology Society (EMBS), Istanbul, Turkey, 2001, and D. Walther, L. Itti, M. Risenhuber, T. Poggio, and C. Koch, “Attentional Selection for Object Recognition—a gentle way,” Procedures in Biology Motivated Computer Vision, pp. 472-249 (2002). However, what is needed is a system and method that selectively enhances perception at the attended location, and successively shifts the focus of attention to multiple locations in order to learn and recognize individual objects in a highly cluttered scene, and identify known objects in the cluttered scene.

### SUMMARY OF THE INVENTION

The present invention provides a system and a method that overcomes the aforementioned limitations and fills the aforementioned needs by providing a system and method that allows automated selection and isolation of salient regions likely to contain objects based on bottom-up visual attention.

The present invention relates to a system and method for attentional selection. More specifically, the present invention relates to a system and method for the automated selection and isolation of salient regions likely to contain objects, based on bottom-up visual attention, in order to allow unsupervised one-shot learning of multiple objects in cluttered images.

In one aspect of the invention, in the act of receiving an input image, automatedly identifying a salient region of the input image, and automatedly isolating the salient region of the input image, resulting in an isolated salient region.

In another aspect, in the act of automatedly identifying, the acts of receiving a most salient location associated with a saliency map, determining a conspicuity map that contributed most to activity at the winning location, providing a feature location on the feature map that corresponds to the conspicuity location, and segmenting the feature map around the around the feature location resulting in a segmented feature map.

In still another aspect, in the act of automatedly isolating, the acts of generating a mask based on the segmented feature map, and modulating the contrast of the input image in accordance with the mask, resulting in a modulated input image.

In yet another aspect, in the act of automatedly identifying, the act of displaying the modulated input image to a user.

In still another aspect, in the act of automatedly identifying, the acts of identifying most active coordinates in the segmented feature map which are associated with the feature location, translating the most active coordinates in the segmented feature map to related coordinates in the saliency map, and blocking the related coordinates in the saliency map from being declared the most salient location, and whereby a new most salient location is identified.

In yet another aspect, the act of repeating the acts of receiving an input image, automatedly identifying a salient region of the input image, and automatedly isolating the salient region of the input image, for the new most salient location.

In still another aspect, the act of providing the isolated salient region to a recognition system, whereby the recognition system either performs an act selected from the group comprising of: identifying an object with the isolated salient region and learning an object within the isolated salient region.

In yet another aspect, the act of providing the object learned by the recognition system to a tracking system.

In still yet another aspect, the act of displaying the object learned by the recognition system to a user.

In yet another aspect, the act of displaying the object identified by the recognition system to a user.

### BRIEF DESCRIPTION OF THE DRAWINGS

The objects, features and advantages of the present invention will be apparent from the following detailed descriptions of the preferred aspect of the invention in conjunction with reference to the following drawings, where:

FIG. 1 depicts a flow diagram model of saliency-based attention, which may be a two-dimensional map that encodes salient objects in a visual environment;

FIG. 2A shows an example of an input image;

FIG. 2B shows an example of the corresponding saliency map of the input image from FIG. 2;

FIG. 2C depicts the feature map with the strongest contribution at (x_{w}, y_{w});

FIG. 2D depicts one embodiment of the resulting segmented feature map;

FIG. 2E depicts the contrast modulated image I′ with keypoints overlayed;

FIG. 2F depicts the resulting image after the mask M modulates the contrast of the original image in FIG. 2A;

FIG. 3 depicts the adaptive thresholding model, which is used to segment the winning feature map;

FIG. 4 depicts keypoints as circles overlayed on top of the original image, for use in object learning and recognition;

FIG. 5 depicts the process flow for selection, learning, and recognizing salient regions;

FIG. 6 displays the results of both attentional selection and random region selection in terms of the objects recognized;

FIG. 7 charts the results of both the attentional selection method and random region selection method in recognizing “good objects;”

FIG. 8A depicts the training image used for learning multiple objects;

FIG. 8B depicts one of the training images for learning multiple objects where only one of two model objects is found;

FIG. 8C depicts one of the training images for learning multiple objects where only one of the two model objects is found;

FIG. 8D depicts one of the training images for learning multiple objects where both of the two model objects are found;

FIG. 9 depicts a table with the recognition results for the two model objects in the training images;

FIG. 10A depicts a randomly selected object for use in recognizing objects in clutter scenes;

FIGS. 10B and 10C depict the randomly selected object being merged into two different background images;

FIG. 11 depicts a chart of the positive identification percentage of each method of identification in relation to the relative object size;

FIG. 12 is a block diagram depicting the components of the computer system used with the present invention; and

FIG. 13 is an illustrative diagram of a computer program product embodying the present invention.

### DETAILED DESCRIPTION

The present invention relates to a system and method for the automated selection and isolation of salient regions likely to contain objects, based on bottom-up visual attention, in order to allow unsupervised one-shot learning of multiple objects in cluttered images. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles, defined herein, may be applied to a wide range of embodiments. Thus, the present invention is not intended to be limited to the embodiments presented, but is to be accorded the widest scope consistent with the principles and novel features disclosed herein. Furthermore, it should be noted that unless explicitly stated otherwise, the Figures included herein are illustrated diagrammatically and without any specific scale, as they are provided as qualitative illustrations of the concept of the present invention.

(1) Introduction

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

The description outlined below sets forth a system and method for the automated selection and isolation of salient regions likely to contain objects, based on bottom-up visual attention, in order to allow unsupervised one-shot learning of multiple objects in cluttered images.

(2) Saliency

The disclosed attention system is based on the work of Koch et al. presented in US Patent Publication No. 2002/0154833 published Oct. 24, 2002, titled “Computation of Intrinsic Perceptual Saliency in Visual Environments and Applications,” incorporated herein by reference in its entirety. This model's output is a pair of coordinates in the image corresponding to a most salient location within the image. Disclosed is a system and method for extracting an image region at salient locations from low-level features with negligible additional computational cost. Before delving into the details of the system and method of extraction, the work of Koch et al. will be briefly reviewed in order to provide a context for the disclosed extensions in the same formal framework. One skilled in the art will appreciate that although the extensions are discussed in context of Koch et al.'s models, these extensions can be applied to other saliency models whose outputs indicate the most salient location within an image.

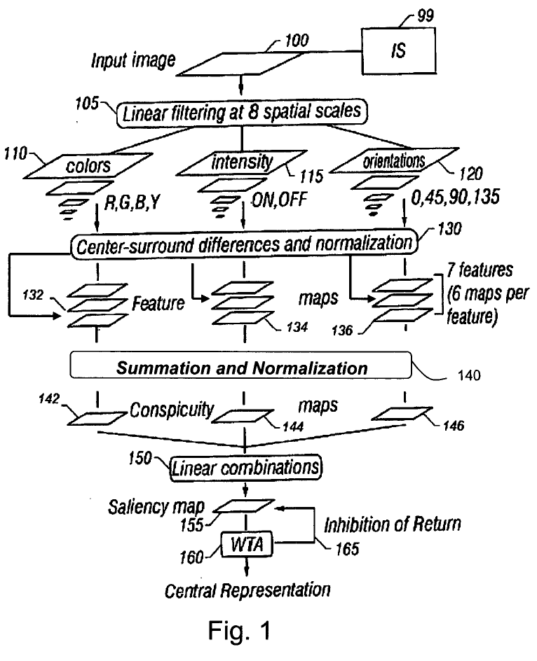

FIG. 1 illustrates a flow diagram model of saliency-based attention, which may be a two-dimensional map that encodes salient objects in a visual environment. The task of a saliency map is to compute a scalar quantity representing the salience at every location in the visual field, and then guide the subsequent selection of attended locations. In essence, filtering is applied to an input image 100 resulting in a plurality of filtered images 110, 115, and 120. These filtered images 110, 115, and 120 are then compared and normalized to result in feature maps 132, 134, and 136. The feature maps 132, 134, and 136 are then summed and normalized to result in conspicuity maps 142, 144, and 146. The conspicuity maps 142, 144, and 146 are then combined, resulting in a saliency map 155. The saliency map 155 is supplied to a neural network 160 whose output is a set of coordinates which represent the most salient part of the saliency map 155. The following paragraphs provide more detailed information regarding the above flow of saliency-based attention.

The input image 100 may be a digitized image from a variety of input sources (IS) 99. In one embodiment, the digitized image may be from an NTSC video camera. The input image 100 is sub-sampled using linear filtering 105, resulting in different spatial scales. The spatial scales may be created using Gaussian pyramid filters of the Burt and Adelson type. These filters may include progressively low-pass filtering and sub-sampling of the input image. The spatial processing pyramids can have an arbitrary number of spatial scales. In the example provided, nine spatial scales provide horizontal and vertical image reduction factors ranging from 1:1 (level 0, representing the original input image) to 1:256 (level 8) in powers of 2. This may be used to detect differences in the image between fine and coarse scales.

Each portion of the image is analyzed by comparing the center portion of the image with the surround part of the image. Each comparison, called center-surround difference, may be carried out at multiple spatial scales indexed by the scale of the center, c, where, for example, c=2, 3 or 4 in the pyramid schemes. Each one of those is compared to the scale of the surround s=c+d, where, for example, d is 3 or 4. This example would yield 6 feature maps for each feature at the scales 2-5, 2-6, 3-6, 3-7, 4-7 and 4-8 (for instance, in the last case, the image at spatial scale 8 is subtracted, after suitable normalization, from the image at spatial scale 4). One feature type encodes for intensity contrast, e.g., “on” and “off” intensity contrast shown as 115. This may encode for the modulus of image luminance contrast, which shows the absolute value of the difference between center intensity and surround intensity. The differences between two images at different scales may be obtained by oversampling the image at the coarser scale to the resolution of the image at the finer scale. In principle, any number of scales in the pyramids, of center scales, and of surround scales, may be used.

Another feature 110 encodes for colors. With r, g and b respectively representing the red, green and blue channels of the input image, an intensity image I is obtained as I−(r+g+b)/3. A Gaussian pyramid I(s) is created from I, where s is the scale. The r, g and b channels are normalized by I at 131, at the locations where the intensity is at least 10% of its maximum, in order to decorrelate hue from intensity.

Four broadly tuned color channels may be created, for example as: R=r−(g+b)/2 for red, G=g−(r+b)/2 for green, B=b−(r+g)/2 for blue, and Y=r+g−2(|r−g|+b for yellow, where negative values are set to zero). Act 130 computes center-surround differences across scales. Two different feature maps may be used for color, a first encoding red-green feature maps, and a second encoding blue-yellow feature maps. Four Gaussian pyramids R(s), G(s), B(s) and Y(s) are created from these color channels. Depending on the input image, many more color channels could be evaluated in this manner.

In one embodiment, the image source 99 that obtains the image of a particular scene is a multi-spectral image sensor. This image sensor may obtain different spectra of the same scene. For example, the image sensor may sample a scene in the infra-red as well as in the visible part of the spectrum. These two images may then be evaluated in a manner similar to that described above.

Another feature type may encode for local orientation contrast 120. This may use the creation of oriented Gabor pyramids as known in the art. Four orientation-selective pyramids may thus be created from 1 using Gabor filtering at 0, 45, 90 and 135 degrees, operating as the four features. The maps encode, as a group, the difference between the average local orientation and the center and surround scales. In a more general implementation, many more than four orientation channels could be used.

From the color 110, intensity 115 and orientation channels 120, center-surround feature maps, ℑ, are constructed and normalized 130:
ℑ_{I,c,s}= [symbol] (|I(c)⊖I(s)|) (1)
ℑ_{RG,c,s}= [symbol] (|(R(c)−G(c))⊖(R(s)−G(s))|) (2)
ℑ_{BY,c,s}= [symbol] (|(B(c)−Y(c))⊖(B(s)−Y(s))|) (3)
ℑ_{θ,c,s}= [symbol] (|O_{θ}(c)⊖O_{θ}(s)|) (4)
where O_{θ} denotes the Gabor filtering at different degrees, ⊖ denotes the across-scale difference between two maps at the center (c) and the surround (s) levels of the respective feature pyramids. [symbol] (·) is an iterative, nonlinear normalization operator. The normalization operator ensures that contributions from different scales in the pyramid are weighted equally. In order to ensure this equal weighting, the normalization operator transforms each individual map into a common reference frame.

In summary, differences between a “center” fine scale c and “surround” coarser scales yield six feature maps for each of intensity contrast (ℑ_{I,c,s}) 132, red-green double opponency (ℑ_{RG,c,s}) 134, blue-yellow double opponency (ℑ_{BY,c,s}) 136, and the four orientations (ℑ_{θ,c,s}) 138. A total of 42 feature maps are thus created, using six pairs of center-surround scales in seven types of features, following the example above. One skilled in the art will appreciate that a different number of feature maps may be obtained using a different number of pyramid scales, center scales, surround scales, or features.

The feature maps 132, 134, 136 and 138 are summed over the center-surround combinations using across scale addition ⊕, and the sums are normalized again:

$$\overline{{𝔍}_{l}} = ℵ ( {⊕}_{c = 2}^{4} {⊕}_{s = c + 3}^{c + 4} {𝔍}_{l , c , s} ) ∀ l ∈ {L}_{I} ⋃ {L}_{C} ⋃ {L}_{O} \qquad ( 5 )$$

with
L_{I}={I},L_{C}={RG,BY},L_{O}={0°,45°,90°,135°}. (6)

For the general features color and orientation, the contributions of the sub-features are linearly summed and the normalized 140 once more to yield conspicuity maps 142, 144, and 146. For intensity, the conspicuity map is the same as \overline{ℑ_{I}} obtained in equation 5. Where C_{I} 144 is the conspicuity map for Intensity, C_{c} 142 is the conspicuity map for color, and Cₒ 146 is the conspicuity map for orientation:

$$\begin{matrix}{C}_{I} = \overline{{𝔍}_{I}} , & {C}_{c} = ℵ ( {\sum }_{l ∈ {L}_{c}} \overline{{𝔍}_{l}} ) , & {C}_{O} = ℵ ( {\sum }_{l ∈ {L}_{O}} \overline{{𝔍}_{l}} )\end{matrix} \qquad ( 7 )$$

All conspicuity maps 142, 144, 146 are combined 150 into one saliency map 155:

$$S = \frac{1}{3} {\sum }_{k ∈ \{ I , C , O \}} {C}_{k} . \qquad ( 8 )$$

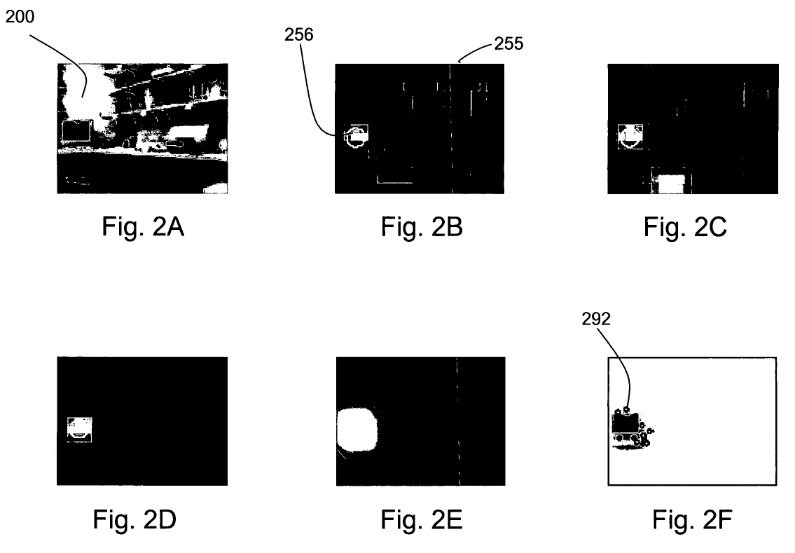

The locations in the saliency map 155 compete for the highest saliency value by means of a winner-take-all (WTA) network 160. In one embodiment the WTA network implemented in a network of integrate-and-fire neurons. FIG. 2A depicts an example of an input image 200 and its corresponding saliency map 255 in FIG. 2B. The winning location (x_{w}, y_{w}) of this process is attended to by the circle 256, where x_{w} and y_{w} are the coordinates of the saliency map where the highest saliency value is found by the WTA.

While with the above disclosed mode, the most salient location in the image is successfully identified, what is needed is a system and method to extend the image region that is salient around this location. Essentially, the disclosed system and method uses the winning location (x_{w}, t_{w}), and then looks to see which of the conspicuity maps 142, 144, and 146 contributed most to the activity at the winning location (x_{w}, y_{w}). Then from the conspicuity map 142, 144 or 146 that contributes most, the feature maps 132, 134 or 136 that make up that conspicuity map 142, 144 or 146 are evaluated to determine which feature map contributed most to the activity at that location in the conspicuity map 142, 144 or 146. The feature map which contributed the most is then segmented. A mask is derived from the segmented feature map, which is then applied to the original image. The result of applying the mask to the original image, is like laying black paper with a hole cut out over the image. Only a portion of the image that is related to the winning location (x_{w}, y_{w}) is visible. The result is that the system automatedly identifies and isolates the salient region of the input image and provides the isolated salient region to a recognition system. One skilled in the art will appreciate the term “automatedly” as used to indicate that the entire process occurs without human intervention, i.e. the computer algorithms isolate different parts of the image without the user pointing or indicating which items should be isolated. The resulting image can then be used by any recognition system to either learn the object, or identify the object from objects it has already learned.

The disclosed system and method estimates an extended region based on the feature and salient maps and salient locations computed thus far. First, looking back at the conspicuity maps, the one map that contributes most to the activity at the most salient location is:

$${k}_{w} = {arg max}_{k ∈ \{ I , C , O \}} {C}_{k} ( {x}_{w} , {y}_{w} ) . \qquad ( 9 )$$

After determining which conspicuity map contributed most to the activity as the most salient location, next the feature map that contributes most to the activity at this location in the conspicuity map Cₖ_{_{w}} is:

$$( {l}_{w} , {c}_{w} , {s}_{w} ) = {arg max}_{l ∈ {L}_{{k}_{w}} , c ∈ \{ 2 , 3 , 4 \} , s ∈ \{ c + 3 , c + 4 \}} {𝔍}_{l , c , s} ( {x}_{w} , {y}_{w} ) , \qquad ( 10 )$$

with Lₖ_{_{w}} as defined in equation 6. FIG. 2C depicts the feature map ℑ_{I}_{_{w}}_{,c}_{_{w}}_{,s}_{w} with the strongest contribution at (x_{w}, y_{w}). In this example, I_{w} equals BY, the blue/yellow contrast map with the center at pyramid level c_{w}=3, and the surround level s_{w}=6.

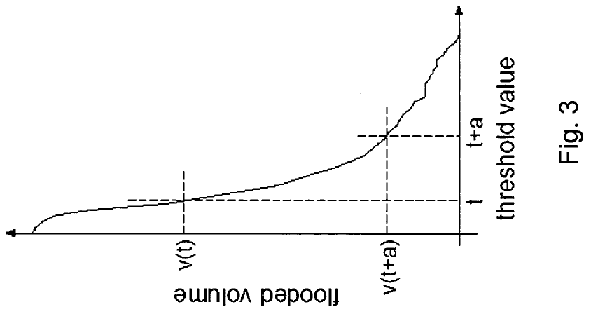

The winning feature map ℑ_{I}_{_{w}}_{,c}_{_{w}}_{,s}_{w} is segmented using region growing around (x_{w}, y_{w}) and adaptive thresholding. FIG. 3 illustrates adaptive thresholding, where a threshold t is adaptively determined for each object, by starting from the intensity value at a manually determined point, and progressively decreasing the threshold by discrete amounts a, until the ratio (r(t)) of flooded object volumes obtained for t and t+a becomes greater than a given constant b. The ratio is determined by:
r(t)=v(t)/v(t+a)>b.

FIG. 2D depicts one embodiment of the resulting segmented feature map ℑ_{w}.

The segmented feature map ℑ_{w} is used as a template to trigger object-based inhibition of return (IOR) in the WTA network, thus enabling the model to attend to several objects subsequently, in order of decreasing saliency.

Essentially, the coordinates identified in the segmented map ℑ_{w} are translated to the coordinates of the saliency map and those coordinates are ignored by the WTA network so the next most salient location is identified.

A mask M is derived at image resolution by thresholding ℑ_{w}, scaling it up and smoothing it with a separate two-dimensional Gaussian kernel (σ=20 pixels). In one embodiment, a computationally efficient method is used comprising of opening the binary mask with a disk of 8 pixels radius as a structuring element, and using the inverse of the chamfer 3-4 distance for smoothing the edges of the region. M is 1 within the attended object, 0 outside the object, and has intermediate values at the edge of the object. FIG. 2E depicts an example of a mask M. The mask M is used to modulate the contrast of the original image I (dynamic range [0,255]) 200, as shown in FIG. 2A. The resulting modulated original image I′ is shown in FIG. 2F, with I′(x,y) represented as below:
I′(x,y)=[255−M(x,y)·(255−I(x,y))], (11)
where [·] symbolizes the rounding operation. Equation 11 is applied separately to the r, g and b channels of the image. I′ is then optionally used as the input to a recognition algorithm instead of L
(3) Object Learning and Recognition

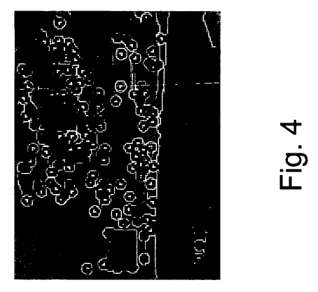

For all experiments described in this disclosure, the object recognition algorithm by Lowe was utilized. One skilled in the art will appreciate that the disclosed system and method may be implemented with other object recognition algorithms and the Lowe algorithm is used for explanation purposes only. The Lowe object recognition algorithm can be found in D. Lowe, “Object recognition from local scale-invariant features, Proceedings of the International Conference on Computer Vision,” pages 1150-1157, 1999, herein incorporated by reference. The algorithm uses a Gaussian pyramid built from a gray-value representation of the image to extract local features, also referred to as keypoints, at the extreme points of differences between pyramid levels. FIG. 4 depicts keypoints as circles overlayed on top of the original image. The keypoints are represented in a 128-dimensional space in a way that makes them invariant to scale and in-plane rotation.

Recognition is performed by matching keypoints found in the test image with stored object models. This is accomplished by searching for nearest neighbors in the 128-dimensional space using the best-bin-first search method. To establish object matches, similar hypotheses are clustered using the Hough transform. Affine transformations relating the candidate hypotheses to the keypoints from the test image are used to find the best match. To some degree, model matching is stable for perspective distortion and rotation in depth.

In the disclosed system and method, there is an additional step of finding salient regions, as described above, for learning and recognition before keypoints are extracted. FIG. 2E depicts the contrast modulated image I′ with keypoints 292 overlayed. Keypoint extraction relies on finding luminance contrast peaks across scales. Once all the contrast is removed from image regions outside the attended object, no keypoints are extracted there, and thus the forming of the model is limited to the attended region.

The number of fixations used for recognition and learning depends on the resolution of the images, and on the amount of visual information. A fixation is a location in an image at which an object is extracted. The number of fixations gives an upper-bound on how many objects can be learned/recognized from a single image. Therefore, the number of fixations depends on the resolution of the image. In low-resolution images with few objects, three fixations may be sufficient to cover the relevant parts of the image. In high-resolution images with a lot of visual information, up to 30 fixations may be required to sequentially attend to all objects. Humans and monkeys, too, need more fixations, to analyze scenes with richer information content. The number of fixations required for a set of images is determined by monitoring after how many fixations the serial scanning of the saliency map starts to cycle.

It is common in object recognition to use interest operators, described or salient feature detectors to select features for learning an object model. Interest operators may be found in C. Harris and M. Stephens, “A Combined Corner and Edge Detector,” In 4^{th} Alvey Vision Conference, pages 147-151, 1998. Salient feature detectors may be found in Scale, Saliency and Image Description by T. Kadir and M. Brady, International Journal of Computer Vision, 30(2):77-116, 2001. These methods are different, however, from selecting an image region and limiting the learning and recognizing objects to this region.

In addition, the learned object may be provided to a tracking system to provide for recognition if the object is discovered again. As will be discussed in the next section, a tracking system, i.e. a robot with a mounted camera, could maneuver around an area. Suppose as the camera on the robot took pictures and the objects were learned, these objects were then classified, and those objects deemed important would be tracked. Thus, when the system recognized an object that had been flagged as important, an alarm would sound to indicate that that object had been recognized in a new location. In addition, a robot with one or several cameras mounted to it, can use a tracking system to maneuver around in an area by continuously learning and recognizing objects. If the robot recognizes a previously learned system of objects, it knows that it has returned to a location it has already visited before.

(4) Experimental Results

In the first experiment, the disclosed saliency-based region selection method is compared with randomly selected image patches. If regions found by the attention mechanism are indeed more likely to contain objects, then one would expect that object learning and recognition to show better performance for these regions than for randomly selected image patches. Since human photographers tend to have a bias towards centering and zooming on objects, a robot is used for collecting a large number of test images in an unbiased fashion.

In this experiment, a robot equipped with a camera as an image acquisition tool was used. The robot's navigation followed a simple obstacle avoidance algorithm using infrared range sensors for control. The camera was mounted on top of the robot at a height of about 1.2 m. Color images were recorded at a resolution of 320×240 pixels at 5 frames per second. A total of 1749 images were recorded during an almost 6 min run. Since vision was not used for navigation, the images taken by the robot are unbiased. The robot moved in a closed environment (indoor offices/labs, four rooms, approximately 80 m²). Hence, the same objects are likely to appear multiple times in the sequence.

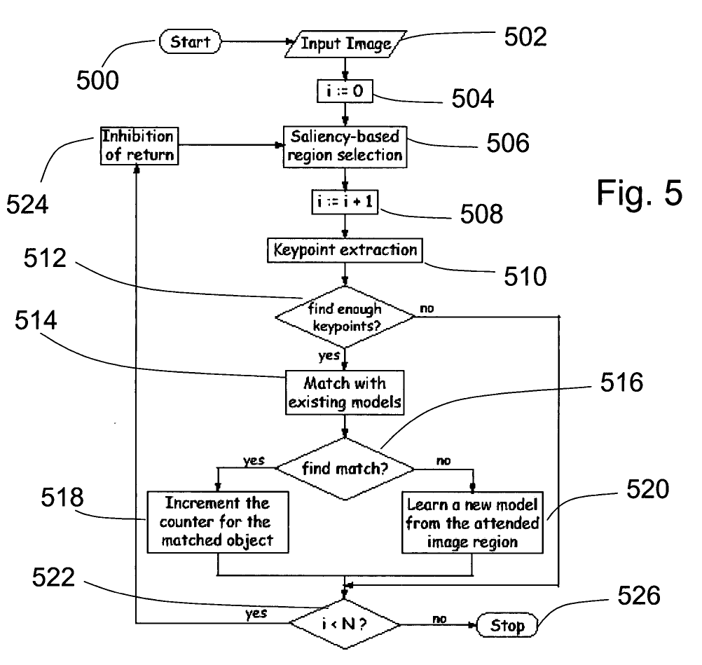

The process flow for selecting, learning, and recognizing salient regions is shown in FIG. 5. First, the act of starting 500 the process flow is performed. Next, an act of receiving an input image 502 is performed. Next, an act of initializing the fixation counter 504 is performed. Next, a system, such as the one described above in the saliency section, is utilized to perform the act of saliency-based region selection 506. Next, an act of incrementing the fixation counter 508 is performed. Next, the saliency-based selected region is passed to a recognition system. In one embodiment, the recognition system performs keypoint extraction 510. Next, an act of determining if enough information is present to make a determination is performed. In one embodiment, this entails determining if there are enough keypoints found 512. Because of the low resolution of the images, only three fixations, i.e. three keypoints, in each image for recognizing and learning objects was used. Next, the identified object is compared with existing models to determine if there is a match 514. If a match is found 516 then an act of incrementing the counter for each matched object 518 is performed. If no match is found, the act of learning the new model from the attended image region 520 is performed. Each newly learned object is assigned a unique label, and the number of times the object is recognized in the entire image set is counted. An object is considered “useful” if it is recognized at least once after learning, thus appearing at least twice in the sequence.

Next an act of comparing i, the number of fixations, to N, the upper bound on the number of fixations, 522 is performed. If i is less than N, then an act of inhibition of returning 524 is performed. In this instance, the previous selected saliency-based region is prevented from being selected and the next most salient region is found. If i is greater than or equal to N, then the process is stopped.

The experiment was repeated without attention, using the recognition algorithm on the entire image. In this case, the system was only capable of detecting large scenes but not individual objects. For a more meaningful control, the experiment was repeated with randomly chosen image regions. These regions were created by a pseudo region growing operation at the saliency map resolution. Starting from a randomly selected location, the original threshold condition for region growth was replaced by a decision based on a uniformly drawn random number. The patches were then treated the same way as true attention patches. The parameters were adjusted such that the random patches have approximately the same size distribution as the attention patches.

Ground truth for all experiments is established manually. This is done by displaying every match established by the algorithm to a human subject who has to rate the match as either correct or incorrect. The false positive rate is derived from the number of patches that were incorrectly associated with an object.

Using the recognition algorithm on the entire images results in 1707 of the 1749 images being pigeon-holed into 38 unique “objects,” representing non-overlapping large views of the rooms visited by the robot. The remaining 42 non-“useful” images are learned as new “objects,” but then never recognized again.

The models learned from these large scenes are not suitable for detecting individual objects. In this experiment, there were 85 false positives (5.0%), i.e. the recognition system indicates a match between a learned model and an image, where the human subject does not indicate an agreement.

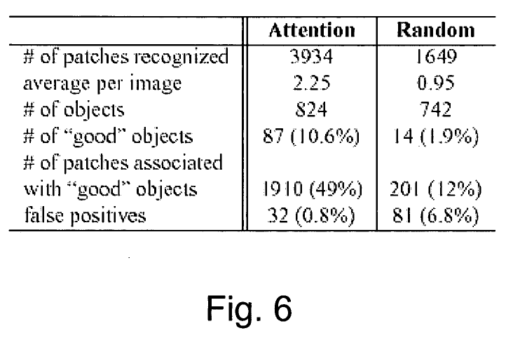

Attentional selection identifies 3934 useful regions in the approximately 6 minutes of processed video, associated with 824 objects. Random region selection only yields 1649 useful regions, associated with 742 objects, see the table presented in FIG. 6. With saliency-based region selection, 32 (0.8%) false positives were found, with random region selection 81 (6.8%) false positives were found.

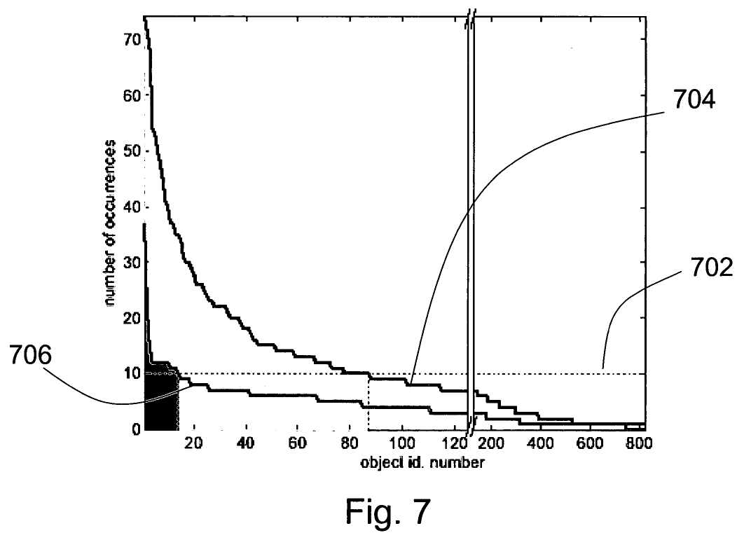

To better compare the two methods of region selection, it is assumed that “good” objects (e.g. objects useful as landmarks for robot navigation) should be recognized multiple times throughout the video sequence, since the robot visits the same locations repeatedly. The objects are sorted by their number of occurrences and set an arbitrary threshold of 10 recognized occurrences for “good” objects for this analysis. FIG. 7 illustrates the results. Objects are labeled with an ID number and listed along the x-axis. Every recognized instance of that object is counted on the y-axis. As previously mentioned, the threshold for “good” objects is arbitrarily set to 10 instances, represented by the dotted line 702. The top curve 704 corresponds to the results using attentional selection and the bottom curve 706 corresponds to the results using random patches.

With this threshold in place, attentional selection finds 87 “good” objects with a total of 1910 patches associated to them. With random regions, only 14 “good” objects are found with a total of 201 patches. The number of patches associated with “good” objects is computed as:

$$\begin{matrix}{N}_{L} = {\sum }_{∀ i : {n}_{i} \geq 10} {n}_{i} & & ( {n}_{i} ∈ ϑ ) ,\end{matrix} \qquad ( 12 )$$

where l is an ordered set of all learned objects, sorted descending by the number of detections.

From these results, one skilled in the art will appreciate that the regions selected by the attentional mechanism are more likely to contain objects that can be recognized repeatedly from various viewpoints than randomly selected regions.

(5) Learning Multiple Objects

In this experiment, the hypothesis that attention can enable the learning and recognizing of multiple objects in single natural scenes is tested. High-resolution digital photographs of home and office environments are used for this purpose.

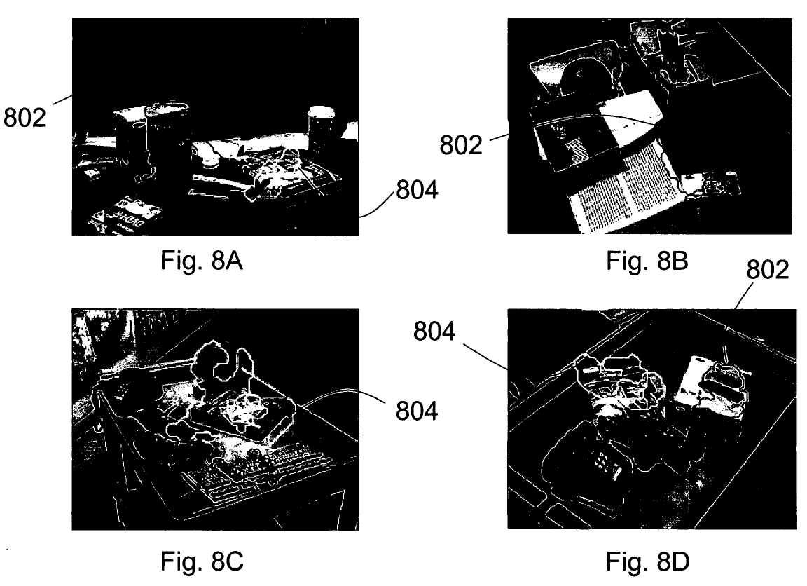

A number of objects are placed into different settings in office and lab environments and pictures are taken of the objects with a digital camera. A set of 102 images at a resolution of 1280×960 pixels was obtained. Images may contain large or small subsets of the objects. One of the images was selected for training. FIG. 8A depicts the training image. Two images within the training image in FIG. 8A were identified, one was the box 702 and the other was the book 704. The other 101 images are used as test images.

For learning and recognition 30 fixations were used, which covers about 50% of the image area. Learning is performed completely unsupervised. A new model is learned at each fixation. During testing, each fixation on the test image is compared to each of the learned models. Ground truth is established manually.

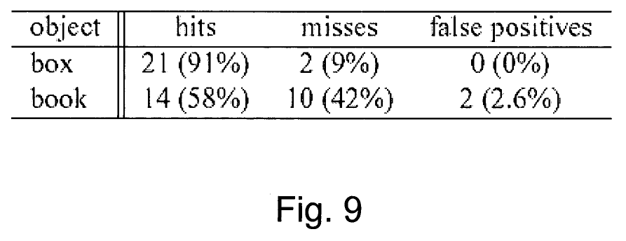

From the training image, the system learns models for two objects that can be recognized in the test images—a book 704 and a box 702. Of the 101 test images, 23 images contained the box, and 24 images contained the book, and of these, four images contain both objects. FIG. 8B shows one image where just the box is found. FIG. 8C shows one image where just the book 704 is found. FIG. 8D shows one image where both the book 704 and box 702 are found. The table in FIG. 9 shows the recognition results for the two objects.

Even though the recognition rates for the two objects are rather low, one should consider that one unlabeled image is the only training input given to the system (one-shot learning). From this one image, the combined model is capable of identifying the book in 58%, and the box in 91% of all cases, with only two false positives for the book, and none for the box. It is difficult to compare this performance with some baseline, since this task is impossible for the recognition system alone, without any attentional mechanism.

(6) Recognizing Objects in Clutter Scenes

As previously shown, selective attention enables the learning of multiple objects from single images. The following section explains how attention can help to recognize objects in highly cluttered scenes.

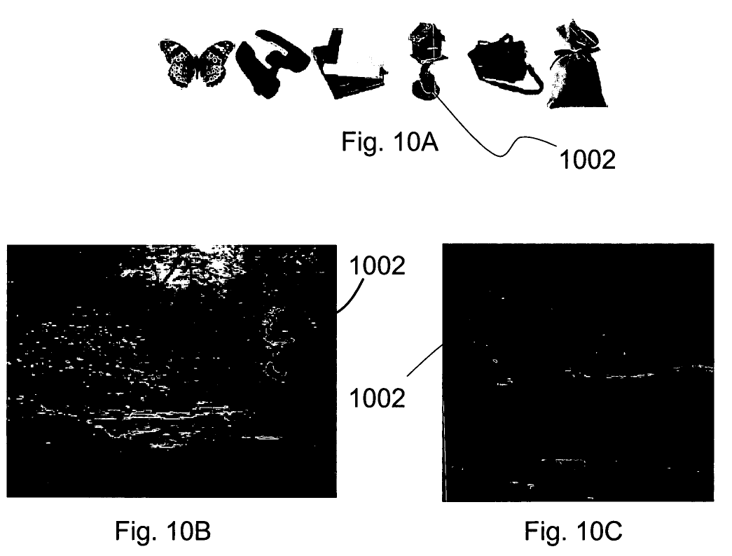

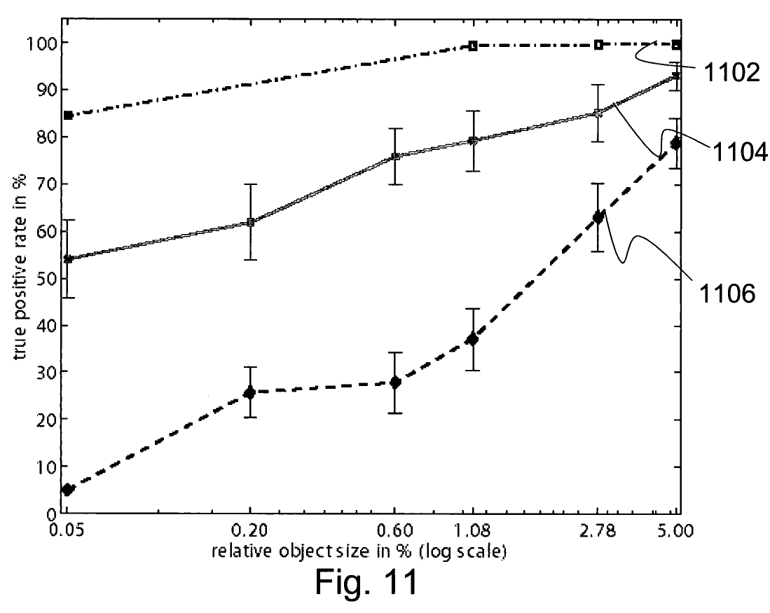

To systematically evaluate recognition performance with and without attention, images generated by randomly merging an object with a background image are used. FIG. 10A depicts the randomly selected bird house 1002. FIGS. 10B and 10C depict the randomly selected bird house 1002 being merged into two different background images.

This design of the experiment enables the generation of a large number of test images in a way that provides good control of the amount of clutter versus the size of the objects in the images, while keeping all other parameters constant. Since the test images are constructed, ground truth is easily accessed. Natural images are used for the backgrounds so that the abundance of local features in the test images matches that of natural scenes as closely as possible.

The amount of clutter in the image is quantified by the relative object size (ROS), defined as the ratio of the number of pixels of the object over the number of pixels in the entire image. To avoid issues with the recognition system due to large variations in the absolute size of the objects, the number of pixels for the objects is left constant (with the exception of intentionally added scale noise), and the ROS is varied by changing the size of the background images in which the objects are embedded.

To introduce variability in the appearance of the objects, each object is rescaled by a random factor between 0.9 and 1.1, and uniformly distributed random noise between −12 and 12 is added to the red, green and blue value of each object pixel (dynamic range is [0, 255]). Objects and backgrounds are merged by blending with an alpha value of 0.1 at the object border, 0.4 one pixel away, 0.8 three pixels away from the border, and 1.0 inside the objects, more than three pixels away from the border. This prevents artificially salient borders due to the object being merged with the background.

Six test sets were created with ROS values of 5%, 2.78%, 1.08%, 0.6%, 0.2% and 0.05%, each consisting of 21 images for training (one training image for each object) and 420 images for testing (20 test images for each object). The background images for training and test sets are randomly drawn from disjoint image pools to avoid false positives due to features in the background. A ROS of 0.05% may seem unrealistically low, but humans are capable of recognizing objects with a much smaller relative object size, for instance for reading street signs while driving.

During training, object models are learned at the five most salient locations of each training image. That is, the object has to be learned by finding it in a training image. Learning is unsupervised and thus, most of the learned object models do not contain an actual object. During testing, the five most salient regions of the test images are compared to each of the learned models. As soon as a match is found, positive recognition is declared. Failure to attend to the object during the first five fixations leads to a failed learning or recognition attempt.

Learning from the data sets results in a classifier that can recognize K=21 objects. The performance of each classifier i is evaluated by determining the number of true positives Tᵢ and the number of false positives Fᵢ. The over-all true positive rate t (also known as detection rate) and the false positive rate f for the entire multi-class classifier are then computed as:

$$\begin{matrix}t = \frac{1}{K} {\sum }_{i = 1}^{K} \frac{{T}_{i}}{N} and & ( 13 ) \\ f = \frac{1}{K} {\sum }_{i = 1}^{K} \frac{{F}_{i}}{\overline{{N}_{i}}} . & ( 14 )\end{matrix}$$

Here Nᵢ is the number of positive examples of class i in the test set, and \overline{Nᵢ} is the number of negative examples of class i. Since in the experiments the negative examples of one class comprise of the positive examples of all other classes, and since they are equal numbers of positive examples for all classes, \overline{Nᵢ} can be written as:

$${\overline{N}}_{i} = {\sum }_{j = 1 , j \neq i}^{K} {N}_{j} = ( K - 1 ) {N}_{i} . \qquad ( 15 )$$

To evaluate the performance of the classifier it is sufficient to consider only the true positive rate, since the false positive rate is consistently below 0.07% for all conditions, even without attention and at the lowest ROS of 0.05%.

The true positive rate for each data set is evaluated with three different methods: (i) learning and recognition without attention; (ii) learning and recognition with attention; and (iii) human validation of attention and shown in FIG. 10. Curve 1002 corresponds to the true positive rate for the set of artificial images evaluated using human validation. Curve 1004 corresponds to the true positive rate for the set of artificial images evaluated using learning and recognition with attention and curve 1006 corresponds to the true positive rate for the set of artificial images evaluated using learning and recognition without attention. The error bars on curves 1004 and 1006 indicate the standard error for averaging over the performance of the 21 classifiers. The third procedure attempts to explain what part of the performance difference between method ii and 100% is due to shortcomings of the attention system, and what part is due to problems with the recognition system.

For human validation, all images that cannot be recognized automatically are evaluated by a human subject. The subject can only see the five attended regions of all training images and of the test images in question, all other parts of the images are blanked out. Solely based on this information, the subject is asked to indicate matches. In this experiment, matches are established whenever the attention system extracts the object correctly during learning and recognition.

In the cases in which the human subject is able to identify the objects based on the attended patches, the failure of the combined system is due to shortcomings of the recognition system. On the other hand, if the human subject fails to recognize the objects based on the patches, the attention system is the component responsible for the failure. As can be seen in FIG. 10, the human subject can recognize the objects from the attended patches in most cases, which implies that the recognition system is the cause for the failure rate. Only for the smallest ROS (0.05%), the attention system contributes significantly to the failure rate.

The results in FIG. 10 demonstrate that attention has a sustained effect on recognition performance for all reported relative object sizes. With more clutter (smaller ROS), the influence of attention becomes more accentuated. In the most difficult cases (ROS of 0.05%), attention increases the true positive rate by a factor of 10.

(7) Embodiments of the Present Invention

The present invention has two principal embodiments. The first is a system and method for the automated selection and isolation of salient regions likely to contain objects, based on bottom-up visual attention, in order to allow unsupervised one-shot learning of multiple objects in cluttered images.

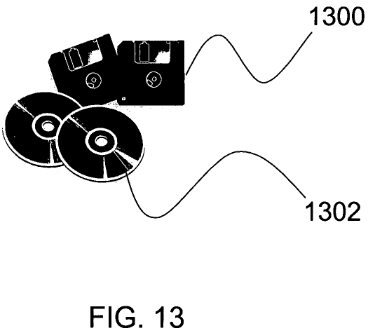

The second principal embodiment is a computer program product. The computer program product may be used to control the operating acts performed by a machine used for the learning and recognizing of objects, thus allowing automation of the method for learning and recognizing of objects. FIG. 13 is illustrative of a computer program product. The computer program product generally represents computer readable code stored on a computer readable medium such as an optical storage device, e.g., a compact disc (CD) 1300 or digital versatile disc (DVD), or a magnetic storage device such as a floppy disk 1302 or magnetic tape. Other, non-limiting examples of computer readable media include hard disks, read only memory (ROM), and flash-type memories. These (aspects) embodiments will be described in more detail below.

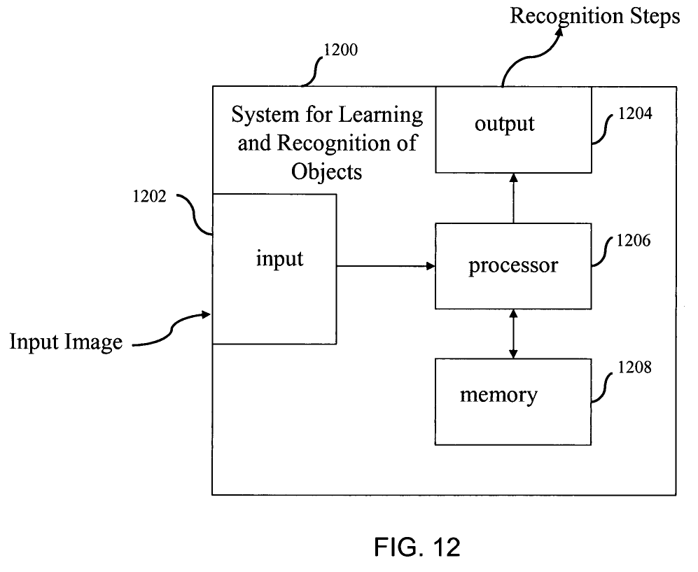

A block diagram depicting the components of a computer system used in the present invention is provided in FIG. 12. The system for learning and recognizing of objects 1200 comprises an input 1202 for receiving a “user-provided” instruction set to control the operating acts performed by a machine or set of machines used to learn and recognize objects. The input 1202 may be configured for receiving user input from another input device such as a microphone, keyboard, or a mouse, in order for the user to easily provide information to the system. Note that the input elements may include multiple “ports” for receiving data and user input, and may also be configured to receive information from remote databases using wired or wireless connections. The output 1204 is connected with the processor 1206 for providing output to the user on a video display, but also possibly through audio signals or other mechanisms known in the art. Output may also be provided to other devices or other programs, e.g. to other software modules, for use therein, possibly serving as a wired or wireless gateway to external machines used to learn and recognize objects, or to other processing devices. The input 1202 and the output 1204 are both coupled with a processor 1206, which may be a general-purpose computer processor or a specialized processor designed specifically for use with the present invention. The processor 1206 is coupled with a memory 1208 to permit storage of data and software to be manipulated by commands to the processor.

1. A method for learning and recognizing objects comprising acts of:
receiving an input image;
automatedly identifying a salient region of the input image; and
automatedly isolating the salient region of the input image, resulting in an isolated salient region.

2. The method of claim 1, wherein the act of automatedly identifying comprises acts of:
receiving a most salient location associated with a saliency map;
determining a conspicuity map that contributed most to activity at the winning location;
providing a conspicuity location on the conspicuity map that corresponds to the most salient location;
determining a feature map that contributed most to activity at the conspicuity location;
providing a feature location on the feature map that corresponds to the conspicuity location; and
segmenting the feature map around the feature location resulting in a segmented feature map.

3. The method of claim 2, wherein the act of automatedly isolating comprises acts of:
generating a mask based on the segmented feature map, and
modulating the contrast of the input image in accordance with the mask, resulting in a modulated input image.

4. The method of claim 2, further comprising an act of:
displaying the modulated input image to a user.

5. The method of claim 2, further comprising acts of:
identifying most active coordinates in the segmented feature map which are associated with the feature location;
translating the most active coordinates in the segmented feature map to related coordinates in the saliency map; and
blocking the related coordinates in the saliency map from being declared the most salient location,
whereby a new most salient location is identified.

6. The method of claim 5, wherein the acts of claim 1 are repeated with the new most salient location.

7. The method of claim 1 further comprising an act of:
providing the isolated salient region to a recognition system,
whereby the recognition system either performs an act selected from the group comprising of: identifying an object within the isolated salient region and learning an object within the isolated salient region.

8. The method of claim 7 further comprising an act of:
providing the object learned by the recognition system to a tracking system.

9. The method of claim 7 further comprising an act of:
displaying the object learned by the recognition system to a user.

10. The method of claim 8 further comprising an act of:
displaying the object identified by the recognition system to a user.

11. A computer program product for learning and recognizing objects, the computer program product comprising computer-executable instructions, stored on a computer-readable medium for causing operations to be performed, for:
receiving an input image;
automatedly identifying a salient region of the input image; and
automatedly isolating the salient region of the input image, resulting in an isolated salient region.

12. A computer program product as set forth in claim 11, further comprising computer-executable instructions, stored on a computer-readable medium for causing, in the act of automatedly identifying, operations of:
receiving a most salient location associated with a saliency map;
determining a conspicuity map that contributed most to activity at the winning location;
providing a conspicuity location on the conspicuity map that corresponds to the most salient location;
determining a feature map that contributed most to activity at the conspicuity location;
providing a feature location on the feature map that corresponds to the conspicuity location; and
segmenting the feature map around the feature location resulting in a segmented feature map.

13. A computer program product as set forth in claim 12, wherein the computer-executable instructions for causing the operations of automatedly isolating are further configured to cause operations of:
generating a mask based on the segmented feature map, and
modulating the contrast of the input image in accordance with the mask, resulting in a modulated input image.

14. A computer program product as set forth in claim 12, further comprising computer-executable instructions for causing the operation of:
displaying the modulated input image to a user.

15. A computer program product as set forth in claim 12, further comprising computer-executable instructions for causing the operation of:
identifying most active coordinates in the segmented feature map which are associated with the feature location;
translating the most active coordinates in the segmented feature map to related coordinates in the saliency map; and
blocking the related coordinates in the saliency map from being declared the most salient location,
whereby a new most salient location is identified.

16. A computer program product as set forth in claim 15, wherein the computer-executable instructions are configured to repeat the operations of claim 11 with the new most salient location.

17. A computer program product as set forth in claim 11, further comprising computer-executable instructions for causing the operations of:
providing the isolated salient region to a recognition system,
whereby the recognition system either performs an act selected from the group comprising of: identifying an object within the isolated salient region and learning an object within the isolated salient region.

18. A computer program product as set forth in claim 17, further comprising computer-executable instructions for causing the operations of:
providing the object learned by the recognition system to a tracking system.

19. A computer program product as set forth in claim 17, further comprising computer-executable instructions for causing the operations of:
displaying the object learned by the recognition system to a user.

20. A computer program product as set forth in claim 18, further comprising computer-executable instructions for causing the operations of:
displaying the object identified by the recognition system to a user.

21. A data processing system for the learning and recognizing of objects, comprising a data processor, having computer-executable instructions incorporated therein, for causing the data processor to perform operations, for:
receiving an input image;
automatedly identifying a salient region of the input image; and
automatedly isolating the salient region of the input image, resulting in an isolated salient region.

22. A data processing system for the learning and recognizing of objects as in claim 21, comprising a data processor, having computer-executable instructions incorporated therein, for causing the data processor, in the act of automatedly identifying, to perform operations of:
receiving a most salient location associated with a saliency map;
determining a conspicuity map that contributed most to activity at the winning location;
providing a conspicuity location on the conspicuity map that corresponds to the most salient location;
determining a feature map that contributed most to activity at the conspicuity location;
providing a feature location on the feature map that corresponds to the conspicuity location; and
segmenting the feature map around the feature location resulting in a segmented feature map.

23. A data processing system for the learning and recognizing of objects as in claim 22, comprising a data processor, having computer-executable instructions incorporated therein, for causing the data processor, in the act of automatedly isolating, to perform operations of:
generating a mask based on the segmented feature map, and
modulating the contrast of the input image in accordance with the mask, resulting in a modulated input image.

24. A data processing system for the learning and recognizing of objects as in claim 22, comprising a data processor, having computer-executable instructions incorporated therein, for causing the data processor to perform operations of:
displaying the modulated input image to a user.

25. A data processing system for the learning and recognizing ofobjects as in claim 22, comprising a data processor, having computer-executable instructions incorporated therein, for causing the data processor to perform operations of:
identifying most active coordinates in the segmented feature map which are associated with the feature location;
translating the most active coordinates in the segmented feature map to related coordinates in the saliency map; and
blocking the related coordinates in the saliency map from being declared the most salient location,
whereby a new most salient location is identified.

26. A data processing system for the learning and recognizing of objects as in claim 25, comprising a data processor, having computer-executable instructions incorporated therein, which are configured to repeat the operations of claim 21 with the new most salient location.

27. A data processing system for the learning and recognizing of objects as in claim 21, comprising a data processor, having computer-executable instructions incorporated therein, for causing the data processor to perform operations of:
providing the isolated salient region to a recognition system,
whereby the recognition system either performs an act selected from the group comprising of: identifying an object within the isolated salient region and learning an object within the isolated salient region.

28. A data processing system for the learning and recognizing of objects as in claim 27, comprising a data processor, having computer-executable instructions incorporated therein, for causing the data processor to perform operations of:
providing the object learned by the recognition system to a tracking system.

29. A data processing system for the learning and recognizing of objects as in claim 27, comprising a data processor, having computer-executable instructions incorporated therein, for causing the data processor to perform operations of:
displaying the object learned by the recognition system to a user.

30. A data processing system for the learning and recognizing of objects as in claim 28, comprising a data processor, having computer-executable instructions incorporated therein, for causing the data processor to perform operations of:
displaying the object identified by the recognition system to a user.
